(19) United States
(12) Patent Application Publication
(10) Pub. No.: US 2013/0301713 A1
(43) Pub. Date: Nov. 14, 2013

(54) SYSTEMS AND METHODS FOR INTRA PREDICTION VIDEO CODING

(71) Applicant: QUALCOMM INCORPORATED, San Diego, CA (US)

(72) Inventors: Stephen Cheung, Richmond Hill (CA); Sumit Mohan, San Diego, CA (US)

(73) Assignee: QUALCOMM INCORPORATED, San Diego, CA (US)

(21) Appl. No.: 13/849,750

(22) Filed: Mar. 25, 2013

Related U.S. Application Data
(60) Provisional application No. 61/646,725, filed on May 14, 2012.
(60) Provisional application No. 61/734,086, filed on Dec. 6, 2012.

(51) Int. Cl. H04N 7/34

(52) U.S. Cl. CPC H04N 19/00763
USPC 375/240.12

(57) ABSTRACT

Systems and methods for intra prediction video coding are described herein. In one aspect, an apparatus includes a processor and a memory. The processor divides a video block into a plurality of video sub-blocks having a first size. The video block includes video units and has an intra prediction mode, and each video sub-block of the plurality of video sub-blocks includes at least a non-zero integer number of video units of the video block. The processor further determines prediction variables for a first video sub-block of the plurality of video sub-blocks based on the intra prediction mode of the video block and determines a predicted video unit for each video unit of the first video sub-block based on the intra prediction mode of the video block and the prediction variables for the first video sub-block. The memory stores the predicted video units.

### CROSS REFERENCE TO RELATED APPLICATIONS

This application claims benefit under 35 U.S.C. §119(e) to U.S. Provisional Patent Application No. 61/646,725 entitled “SYSTEMS AND METHODS FOR INTRA PREDICTION VIDEO ENCODING” filed on May 14, 2012; the disclosure of which is hereby incorporated by reference in its entirety. In addition, this application claims benefit under 35 U.S.C. §119(e) to U.S. Provisional Patent Application No. 61/734,086 entitled “SYSTEMS AND METHODS FOR INTRA PREDICTION VIDEO CODING” filed on Dec. 6, 2012; the disclosure of which is hereby incorporated by reference in its entirety

### FIELD

This disclosure generally relates to video coding, and in particular to intra prediction video coding.

### BACKGROUND

Digital video coding is used in wide range of devices, including digital televisions, digital direct broadcast systems, wireless communication devices, personal digital assistants (PDAs), laptop or desktop computers, digital cameras, digital recording devices, video gaming devices, cellular or satellite radio telephones, or the like. Digital video devices implement video compression techniques, such as MPEG-2, MPEG-4, or H.264/MPEG-4 Advanced Video Coding (AVC), to transmit and receive digital video more efficiently.

Video compression techniques generally perform spatial prediction, motion estimation, and motion compensation to reduce or remove redundancy inherent in video data. Intra prediction video coding relies on spatial prediction to reduce or remove spatial redundancy in video within a given video frame.

### SUMMARY

The systems, methods, and devices of this disclosure each have several innovative aspects, no single one of which is solely responsible for the desirable attributes disclosed herein.

One aspect of this disclosure provides an apparatus for coding video data including video blocks, the apparatus comprising a processor and a memory. The processor is configured to: divide a video block into a plurality of video sub-blocks having a first size, the video block comprising video units and having an intra prediction mode, each video sub-block of the plurality of video sub-blocks comprising at least a non-zero integer number of video units of the video block; determine prediction variables for a first video sub-block of the plurality of video sub-blocks based on the intra prediction mode of the video block; and determine a predicted video unit for each video unit of the first video sub-block based on the intra prediction mode of the video block and the prediction variables for the first video sub-block. The memory is configured to store the predicted video units.

Another aspect of this disclosure provides a method for coding video data including video blocks, the method comprising: dividing a video block into a plurality of video sub-blocks having a first size, the video block comprising video units and having an intra prediction mode, each video sub-block of the plurality of video sub-blocks comprising at least a non-zero integer number of video units of the video block; determining prediction variables for a first video sub-block of the plurality of video sub-blocks based on the intra prediction mode of the video block; and determining a predicted video unit for each video unit of the first video sub-block based on the intra prediction mode of the video block and the prediction variables for the first video sub-block.

One aspect of this disclosure provides an apparatus for coding video data including video blocks, the apparatus comprising: means for dividing a video block into a plurality of video sub-blocks having a first size, the video block comprising video units and having an intra prediction mode, each video sub-block of the plurality of video sub-blocks comprising at least a non-zero integer number of video units of the video block; means for determining prediction variables for a first video sub-block of the plurality of video sub-blocks based on the intra prediction mode of the video block; and means for determining a predicted video unit for each video unit of the first video sub-block based on the intra prediction mode of the video block and the prediction variables for the first video sub-block.

Another aspect of this disclosure provides a non-transitory computer-readable storage medium comprising instructions that upon execution in a processor cause the processor to: divide a video block into a plurality of video sub-blocks, the video block comprising video units and having an intra prediction mode, each video sub-block of the plurality of video sub-blocks comprising at least a non-zero integer number of video units of the video block; determine prediction variables for a first video sub-block of the plurality of video sub-blocks based on the intra prediction mode of the video block; and determine a predicted video unit for each video unit of the first video sub-block based on the intra prediction mode of the video block and the prediction variables for the first video sub-block.

### BRIEF DESCRIPTION OF DRAWINGS

FIG. 1 is a block diagram illustrating an example video encoding and decoding system.

FIG. 2 is a block diagram illustrating an example video encoder.

FIG. 3A is a block diagram illustrating an example intra prediction unit of a video encoder.

FIG. 3B is a block diagram illustrating an example intra prediction unit of a video encoder.

FIGS. 4A-4C illustrate an example intra prediction determination.

FIGS. 5A-5C illustrate an example intra prediction determination.

FIGS. 6A-6D illustrate an example intra prediction determination.

FIG. 7 is a flowchart of an example method of determining predicted video units of a video block.

FIG. 8 is a flowchart of an example method for determining predicted video units of a video sub-block.

FIG. 9 is a functional block diagram of an example video coder configured to perform intra prediction.

### DETAILED DESCRIPTION

In general, this disclosure is directed to architectures and techniques for intra prediction video coding. The term “coding,” as used herein, may refer to encoding, decoding or both. Although the techniques described in this disclosure may be applicable to a wide variety of practical applications, the disclosure will refer to digital video encoding and decoding for purposes of example and illustration.

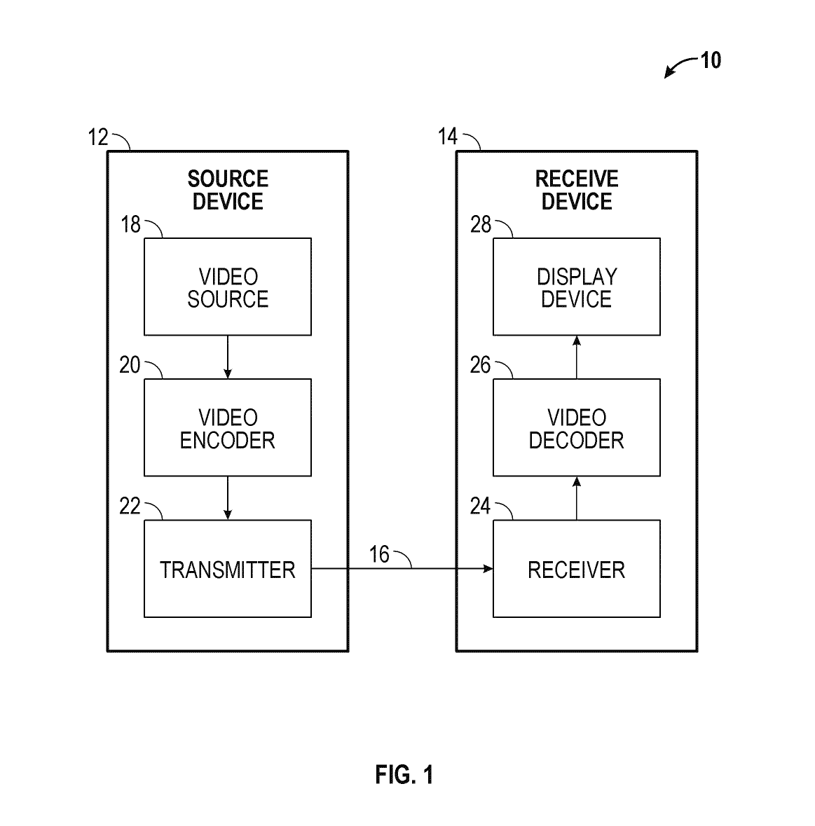

FIG. 1 is a block diagram illustrating a video encoding and decoding system 10. As shown in FIG. 1, system 10 includes a source device 12 that transmits encoded video to a receive device 14 via a communication channel 16. Source device 12 may include a video source 18, video encoder 20, and a transmitter 22. Receive device 14 may include a receiver 24, video decoder 26, and video display device 28. System 10 may be configured to apply techniques for intra prediction video coding in accordance with this disclosure.

In the example of FIG. 1, communication channel 16 may comprise any wireless or wired communication medium, such as a radio frequency (RF) spectrum or one or more physical transmission lines, or any combination of wireless and wired media. Channel 16 may form part of a packet-based network, such as a local area network, wide-area network, or a global network such as the Internet. Communication channel 16 generally represents any suitable communication medium, or collection of different communication media, for transmitting video data from source device 12 to receive device 14.

Source device 12 generates video for transmission to destination device 14. In some cases, however, devices 12, 14 may operate in a substantially symmetrical manner. For example, each of devices 12, 14 may include video encoding and decoding components. Hence, system 10 may support one-way or two-way video transmission between video devices 12, 14, e.g., for video streaming, video broadcasting, or video telephony. For other data compression and coding applications, devices 12, 14 could be configured to send and receive, or exchange, other types of data, such as image, speech or audio data, or combinations of two or more of video, image, speech and audio data. Accordingly, discussion of video encoding and decoding applications is provided for purposes of illustration and should not be considered limiting of the various aspects of the disclosure as broadly described herein.

Video source 18 may include a video capture device, such as one or more video cameras, a video archive containing previously captured video, or a live video feed from a video content provider. As a further alternative, video source 18 may generate computer graphics-based data as the source video, or a combination of live video and computer-generated video. In some cases, if video source 18 is a camera, source device 12 and receive device 14 may form so-called camera phones or video phones. Hence, in some aspects, source device 12, receive device 14 or both may form a wireless communication device handset, such as a mobile telephone handset. In each case, the captured, pre-captured or computer-generated video may be encoded by video encoder 20 for transmission from video source device 12 to video decoder 26 of video receive device 14 via transmitter 22, channel 16, and receiver 24. Display device 28 may include any of a variety of display devices such as a liquid crystal display (LCD), plasma display, or organic light emitting diode (OLED) display.

Video encoder 20 and video decoder 26 may be configured to support scalable video coding (SVC) for spatial, temporal, and/or signal-to-noise ratio (SNR) scalability. In some aspects, video encoder 20 and video decoder 26 may be configured to support fine granularity SNR scalability (FGS) coding for SVC. Encoder 20 and decoder 26 may support various degrees of scalability by supporting encoding, transmitting, and decoding of a base layer and one or more scalable enhancement layers. For scalable video coding, a base layer carries video data with a minimum level of quality. One or more enhancement layers carry additional bitstream to support higher spatial, temporal, and/or SNR levels.

Video encoder 20 and video decoder 26 may operate in part according to techniques described herein and in part according to a video compression standard, such as MPEG-2, MPEG-4, ITU-T H.263, ITU-T H.264/MPEG-4 Advanced Video Coding (AVC), or High Efficiency Video Coding (HEVC). For example, the techniques used herein may be used to augment or replace the respective techniques used in a video compressions standard. Although not shown in FIG. 1, in some aspects, video encoder 20 and video decoder 26 may be integrated with an audio encoder and decoder, respectively, and include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP). In general, video decoder 26 may perform inverse operations to video encoder 20, including decoding and parsing to decode and reconstruct the encoded video.

The H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). The H.264 standard is described in ITU-T Recommendation H.264, Advanced video coding for generic audiovisual services, by the ITU-T Study Group, and dated March 2005, which may be referred to herein as the H.264 standard or H.264 specification, or the H.264/AVC standard or specification.

In some aspects, for video broadcasting, the techniques described in this disclosure may be applied to Enhanced H.264 video coding for delivering real-time video services in terrestrial mobile multimedia multicast (TM3) systems using the Forward Link Only (FLO) Air Interface Specification, “Forward Link Only Air Interface Specification for Terrestrial Mobile Multimedia Multicast,” to be published as Technical Standard TIA-1099 (the “FLO Specification”), e.g., via a wireless video broadcast server or wireless communication device handset. The FLO Specification includes examples defining bitstream syntax and semantics and decoding processes suitable for the FLO Air Interface. Alternatively, video may be broadcasted according to other standards such as DVB-H (digital video broadcast-handheld), ISDB-T (integrated services digital broadcast-terrestrial), or DMB (digital media broadcast). Hence, source device 12 may be a mobile wireless terminal, a video streaming server, or a video broadcast server. However, techniques described in this disclosure are not limited to any particular type of broadcast, multicast, or point-to-point system. In the case of broadcast, source device 12 may broadcast several channels of video data to multiple receive device, each of which may be similar to receive device 14 of FIG. 1.

Video encoder 20 and video decoder 26 each may be implemented as one or more microprocessors, digital signal processors (DSPs), application specific integrated circuits (ASICs), field programmable gate arrays (FPGAs), discrete logic, software, hardware, firmware or any combinations thereof. Hence, each of video encoder 20 and video decoder 26 may be implemented at least partially as an integrated circuit (IC) chip or device, and included in one or more encoders or decoders, either of which may be integrated as part of a combined encoder/decoder (CODEC) in a respective mobile device, subscriber device, broadcast device, server, or the like. In addition, source device 12 and receive device 14 each may include appropriate modulation, demodulation, frequency conversion, filtering, and amplifier components for transmission and reception of encoded video, as applicable, including radio frequency (RF) wireless components and antennas sufficient to support wireless communication. For ease of illustration, however, such components are not shown in FIG. 1.

A video sequence includes a series of video frames. Video encoder 20 operates on blocks composed of video units, such as pixels, within individual video frames in order to encode the video data. The video blocks may have fixed or varying sizes, and may differ in size according to a specified coding standard. Each video frame includes a series of slices. Each slice may include a series of macroblocks (MBs) or coding units (CUs), which may be arranged into video blocks or sub-blocks. As an example, the ITU-T H.264 standard supports intra prediction in various block sizes, such as 16×16, 8×8, 4×4 for luma components, and 8×8 for chroma components, as well as inter prediction in various block sizes, such as 16×16, 16×8, 8×16, 8×8, 8×4, 4×8 and 4×4 for luma components and corresponding scaled sizes for chroma components.

Smaller video blocks can provide better resolution, and may be used for locations of a video frame that include higher levels of detail. In general, MBs, CUs, and the various sub-blocks may be considered to be video blocks. In addition, a slice may be considered to be a series of video blocks, such as MBs and/or sub-blocks. Each slice may be an independently decodable unit. After prediction, a transform may be performed on the 8×8 residual block or 4×4 residual block, and an additional transform may be applied to the DC coefficients of the 4×4 blocks for chroma components or luma component if the intra 16×16 prediction mode is used.

Video encoder 20 of system 10 of FIG. 1 may be configured to employ techniques for intra prediction video encoding as described in this disclosure. In particular, video encoder 20 may include an intra predictor that applies at least some of the techniques to improve encoding scalability in processing different block shapes or new coding standards and reduce intra prediction video coding hardware. Moreover, video encoder 20 including an intra predictor as described herein may reduce the number of filters or registers needed to support different intra block shapes and intra prediction modes of video compression techniques.

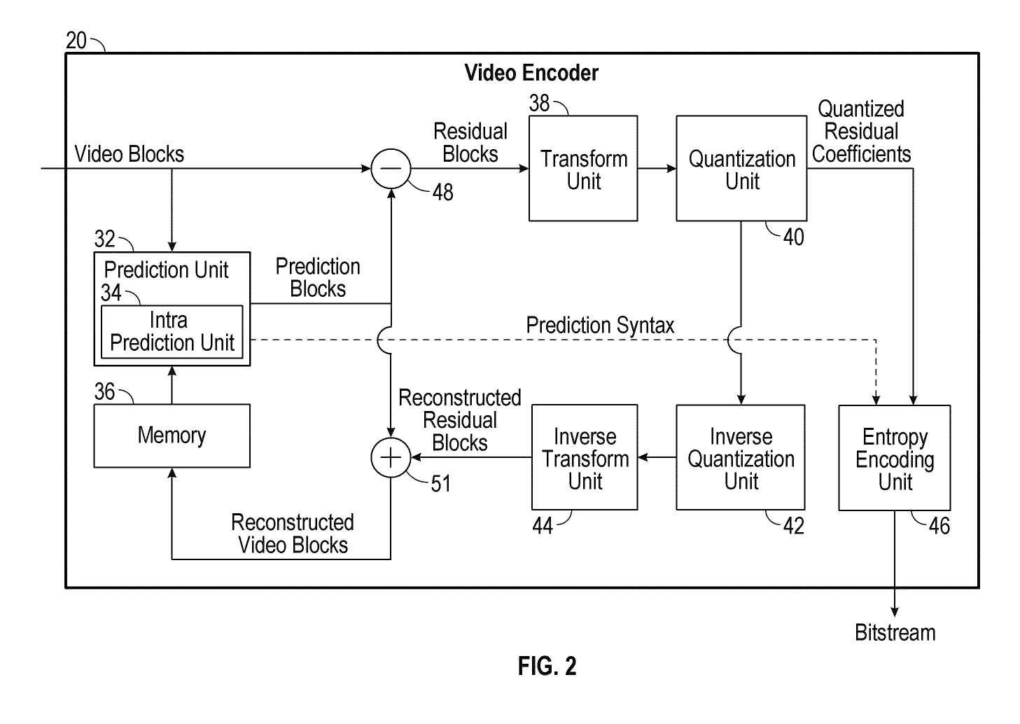

FIG. 2 is a block diagram illustrating an example video encoder 20 as shown in FIG. 1. Video encoder 20 may be formed at least in part as one or more integrated circuit devices, which may be referred to collectively as an integrated circuit device. In some aspects, video encoder 20 may form part of a wireless communication device handset or broadcast server. Video encoder 20 may perform intra and inter coding of video blocks within video frames.

As shown in FIG. 2, video encoder 20 may include prediction unit 32, adders 48 and 51, and memory 36. Video encoder 20 may also include transform unit 38 and quantization unit 40, as well as inverse quantization unit 42 and inverse transform unit 44. Video encoder 20 may also include entropy encoding unit 46. One or more filters (not shown) may additionally be implemented in the encoding process.

During the encoding process, video encoder 20 receives a video block including video units to be coded, and prediction unit 32 performs predictive coding techniques. For inter coding, prediction unit 32 may compare the video block to be encoded to various blocks in one or more video reference frames or slices in order to define a predictive block. For intra coding, prediction unit 32 may determine whether the video block is a block having a baseline block size or a baseline total number of video units. If the video block is larger than the baseline block size or has more video units than the baseline total number of video units, prediction unit 32 may divide the video block into sub-blocks having the baseline block size or the baseline total number of video units.

Intra prediction unit 34 of prediction unit 32 may generate a prediction block or prediction sub-block for each block or sub-block having the baseline block size or the baseline total number of video units. In some aspects, intra prediction unit 34 may only generate prediction blocks or prediction sub-blocks for blocks or sub-blocks having the baseline block size or the baseline total number of video units. Intra prediction unit 34 may generate a prediction block or prediction sub-block based on neighboring video units of at least one neighboring video block of the video block to be encoded. One or more intra prediction modes (e.g., directional mode, mean mode, or planar mode, and the like) may determine how an intra prediction block or sub-block may be defined. In addition, if prediction unit 32 generates prediction sub-blocks for multiple sub-blocks of a video block, intra prediction unit 34 may construct a prediction block having a size equal to the size of the video block using one or more of the generated prediction sub-blocks. Prediction unit 32 may output the prediction block, and adder 48 subtracts the prediction block from the video block being coded in order to generate a residual block. In some aspects, prediction unit 32 includes more than one intra prediction unit 34 to enable substantially parallel processing of multiple sub-blocks and thus faster processing of video blocks. For instance, each intra prediction unit 34 may separately process one sub-block of one video block so that multiple sub-blocks of the one video block can be encoded in parallel. In such cases, predicted video units or prediction variables for multiple sub-blocks can be determined in parallel.

After prediction unit 32 outputs the prediction block and adder 48 subtracts the prediction block from the video block being coded in order to generate a residual block, transform unit 38 applies a transform to the residual block. The transform may comprise a discrete cosine transform (DCT) or a conceptually similar transform, such as that defined by the H.264 or HEVC standard. Wavelet transforms, integer transforms, sub-band transforms or other types of transforms may be used. Transform unit 38 applies the transform to the residual block, producing a block of residual transform coefficients. The transform may convert the residual information from a pixel domain to a frequency domain.

Quantization unit 40 quantizes the residual transform coefficients to further reduce bit rate. Quantization unit 40, for example, may limit the number of bits used to code each of the coefficients. After quantization, entropy encoding unit 46 scans the quantized coefficient block from a two-dimensional representation to one or more serialized one-dimensional vectors. The scan order may be pre-programmed to occur in a defined order (such as zig-zag scanning or another pre-defined order), or adaptively defined based on previous coding statistics, for instance.

Following this scanning process, entropy encoding unit 46 may encode the quantized transform coefficients (along with any syntax elements) according to an entropy coding methodology, such as CAVLC or CABAC, to further compress the data. Syntax elements included in the entropy coded bitstream may include prediction syntax from prediction unit 32, such as motion vectors for inter coding or prediction modes for intra coding. Syntax elements included in the entropy coded bitstream may also include filter information or other data that may be used in the decoding process.

Following the entropy coding by entropy encoding unit 46, the encoded video may be transmitted to another device or archived for later transmission or retrieval. Again, the encoded video may comprise the entropy coded motion vectors and other various syntax that may be used by the decoder to properly configure the decoding process. Inverse quantization unit 42 and inverse transform unit 44 apply inverse quantization and inverse transform, respectively, to reconstruct the residual block in the pixel domain. Adder 51 adds the reconstructed residual block to the prediction block produced by prediction unit 32 to produce a reconstructed video block for storage in memory 36. Prior to such storage, filtering may also be applied on the video block to improve video quality. Such filtering may reduce blockiness or other artifacts, and may be performed in loop (in which case the data used for prediction may be filtered data) or post loop (in which case the data used for prediction may be unfiltered data).

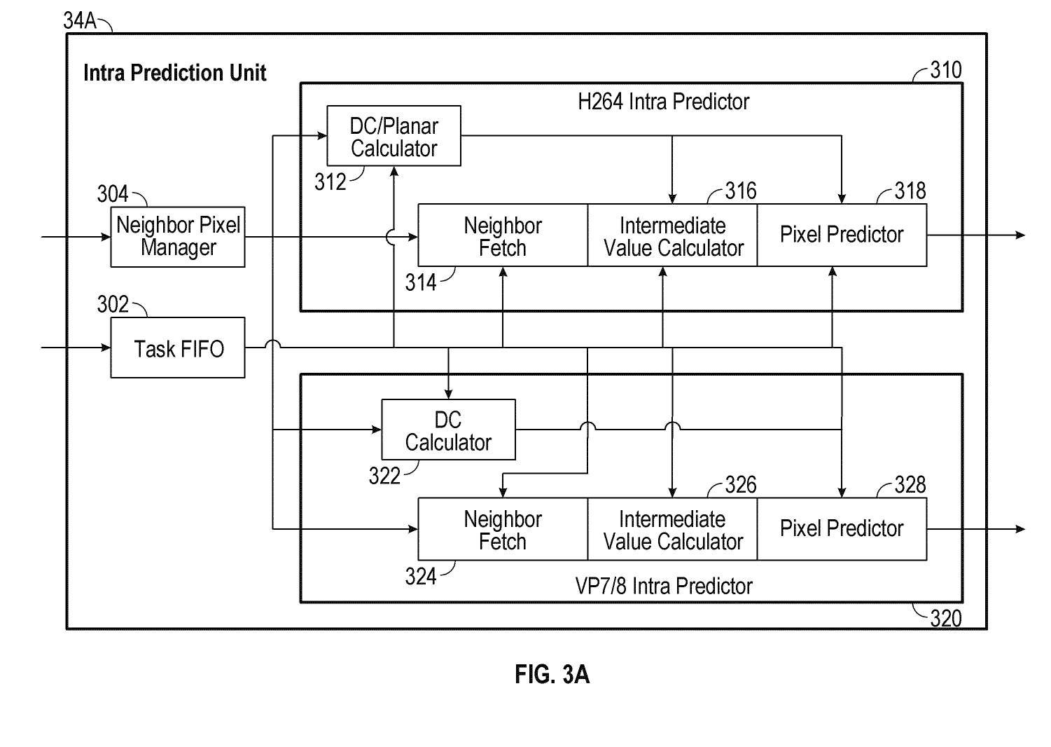

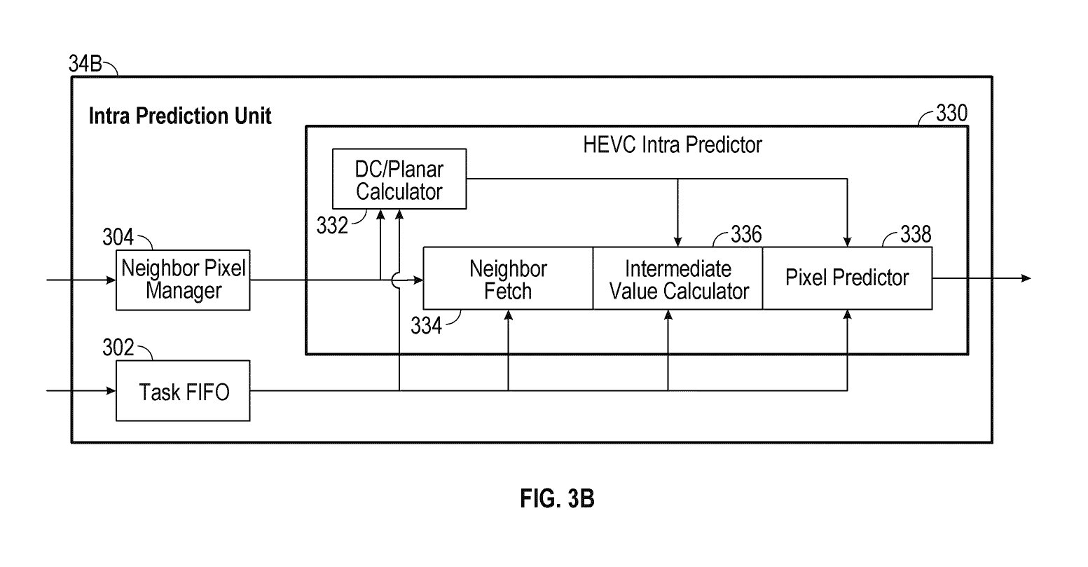

FIG. 3A is a block diagram illustrating an example intra prediction unit 34A of prediction unit 32 of video encoder 20 of FIG. 2. Intra prediction unit 34A may perform intra prediction encoding as discussed in this disclosure. Advantageously, in some aspects, intra prediction unit 34A may independently perform intra prediction for video sub-blocks of a video block based in part on the intra prediction mode for the video block. Thereby, prediction unit 32 of video encoder 20 may then construct a prediction video block for the video block. Moreover, in some aspects, intra prediction unit 34A may be configured to communicate or work with one or more other intra prediction units, such as another intra prediction unit 34A, to facilitate parallel processing of multiple video sub-blocks by prediction unit 32 of video encoder 20.

Although intra prediction unit 34A is illustrated as including H.264 intra predictor 310 and VP 7/8 intra predictor 320, intra prediction unit 34 may include one or more other predictors configured to perform other intra prediction standards or approaches. In some aspects, intra prediction unit 34A includes shared or common hardware and/or software for performing one or more functions of some or all predictors. For example, shared hardware or software may perform functions of DC/planar calculator 312 of H.264 intra predictor 310 and functions of DC calculator 322 of VP 7/8 intra predictor 320. As another example, shared hardware or software may perform functions of neighbor fetch module 314 of H.264 intra predictor 310 and functions of neighbor fetch module 324 of VP 7/8 intra predictor 320. Similarly, shared hardware or software may perform functions of intermediate value calculator module 316 and intermediate value calculator module 326, and shared hardware and/or software may perform functions of pixel predictor module 318 and pixel predictor module 328.

Intra prediction unit 34A may include task FIFO (first-in first-out) module 302 configured to control processing of video units by intra prediction unit 34A. Task FIFO module 302 may receive video blocks or sub-blocks having a baseline block size or a baseline total number of video units and control the intra prediction processing of each block or sub-block by the modules of H.264 intra predictor 310 and VP 7/8 intra predictor 320.

Intra prediction unit 34A may include neighbor pixel manager module 304. Neighbor pixel manager module 304 may determine, store, and/or provide neighboring video unit information such as pixel values of neighboring video units of neighboring video blocks previously processed by task FIFO module 302. For instance, neighbor pixel manager module 304 may determine a video block currently being processed by task FIFO module 302 and obtain neighboring video unit information for the video block from memory 36 of FIG. 2. In some aspects, neighbor pixel manager module 304 may serve to augment neighbor pixel buffers and reference original neighbor pixels to the block. Neighbor pixel manager module 304 may further store and/or provide the neighbor video unit information to DC/planar calculator module 312 and neighbor fetch module 314 of H.264 intra predictor 310 and to DC calculator module 322 and neighbor fetch module 324 of VP 7/8 intra predictor 320 for processing.

H.264 intra predictor 310 may include DC/planar calculator module 312, neighbor fetch module 314, intermediate value calculator module 316, and pixel predictor module 318. DC/planar calculator module 312 and neighbor fetch module 314 may receive inputs from task FIFO module 302 and neighbor pixel manager module 304, including a video block or sub-block to be predicted and neighboring video unit information for the video block. Depending on the intra prediction mode for the video block to be predicted, DC/planar calculator module 312 may calculate parameters based on neighboring video units. Intermediate value calculator module 316 may receive from DC/planar calculator module 312 and/or neighbor fetch module 314 prediction variables, including neighboring video unit information or parameters calculated based on neighboring video units. Intermediate value calculator module 316 may use the prediction variables to determine one or more predicted video units based on the intra prediction mode for the video block, for example, by filtering and generating a minimum number of unique video units. Pixel predictor module 318 may receive from DC/planar calculator module 312 and intermediate value calculator 316 the prediction variables and the one or more predicted video units and thereby determine and output a predicted video unit for each video unit of the video block or sub-block to be predicted. Pixel predictor module 318 may further include a memory for storing the predicted video units.

VP 7/8 intra predictor 320 may include DC calculator module 322, neighbor fetch module 324, intermediate value calculator module 326, and pixel predictor module 328. DC calculator module 322 and neighbor fetch module 324 may receive inputs from task FIFO module 302 and neighbor pixel manager module 304, including a video block or sub-block to be predicted and neighboring video unit information for the video block. Depending on the intra prediction mode for the video block or sub-block to be predicted, DC calculator module 322 may calculate parameters based on neighboring video units. Intermediate value calculator module 326 may receive from DC calculator module 322 and/or neighbor fetch module 324 prediction variables, including neighboring video unit information or parameters calculated based on neighboring video units. Intermediate value calculator module 326 may use the prediction variables to determine one or more predicted video units based on the intra prediction mode for the video block, for example, by filtering and generating a minimum number of unique video units. Pixel predictor module 328 may receive from DC calculator module 322 and intermediate value calculator 326 the prediction variables and the one or more predicted video units and thereby determine and output a predicted video unit for each video unit of the video block or sub-block to be predicted. Pixel predictor module 328 may further include a memory for storing the predicted video units.

FIG. 3B is a block diagram illustrating an example intra prediction unit 34B of prediction unit 32 of video encoder 20 of FIG. 2. Intra prediction unit 34B may perform intra prediction encoding as discussed in this disclosure. Intra prediction unit 34B may function similarly to intra prediction unit 34A although HEVC intra predictor 330 may enable intra prediction unit 34B to perform intra coding according to the HEVC standard. Under the HEVC standard, coding units (e.g., 32×32, 16×16, 8×8, or 4×4 coding units) may be the video blocks processed by the HEVC intra predictor 330. In some aspects, intra prediction unit 34B may be configured to communicate or work with one or more other intra prediction units, such as another intra prediction unit 34B, to facilitate parallel processing of multiple video sub-blocks by prediction unit 32 of video encoder 20.

HEVC intra predictor 330 may include DC/Planar calculator module 332, neighbor fetch module 334, intermediate value calculator module 336, and pixel predictor module 338. DC/planar calculator module 332 and neighbor fetch module 334 may receive inputs from task FIFO module 302 and neighbor pixel manager module 304, including a video block or sub-block to be predicted and neighboring video unit information for the video block. Depending on the intra prediction mode for the video block or sub-block to be predicted, DC calculator module 332 may calculate parameters based on neighboring video units. Intermediate value calculator module 336 may receive from DC calculator module 332 and/or neighbor fetch module 334 prediction variables, including neighboring video unit information or parameters calculated based on neighboring video units. Intermediate value calculator module 336 may use the prediction variables to determine one or more predicted video units based on the intra prediction mode for the video block, for example, by filtering and generating a minimum number of unique video units. Pixel predictor module 338 may receive from DC calculator module 332 and intermediate value calculator 336 the prediction variables and the one or more predicted video units and thereby determine and output a predicted video unit for each video unit of the video block or sub-block to be predicted. Pixel predictor module 338 may further include a memory for storing the predicted video units.

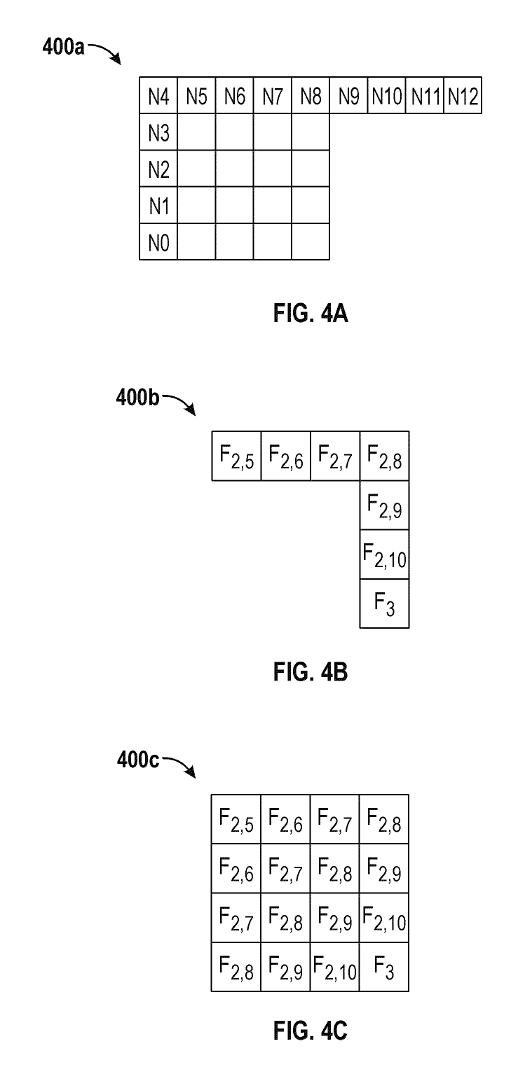

FIGS. 4A-4C illustrate an example intra prediction determination. FIG. 4A shows a 4×4 block 400a arranged for diagonal down left (DDL) mode intra prediction. The thirteen border squares N0, N1, . . . , N12 may represent some or all video units from neighboring video blocks that have been fetched, for example, by neighbor pixel manager module 304 of FIG. 3A. Further, the thirteen border squares N0, N1, . . . , N12 may be the set of video units from which neighbor fetch module 314 or 324 of FIG. 3A fetches prediction variables or a subset of video units for use in intra prediction. FIG. 4B shows the placement of seven unique predicted video units 400b calculated as function of the prediction variables or appropriate border squares to the 4×4 block, according to DLL mode intra prediction. For instance, the top-right corner square may equal a pixel value that is a function in part of border square N8 as indicated by F_{2,8}. The calculation of predicted video units 400b in this instance may take one processor cycle to complete using intermediate value calculator module 316 or 326 of intra prediction unit 34A of FIG. 3A, for example. FIG. 4C shows the placement of the unique predicted video units in squares of a 4×4 predicted video units block 400c, according to DLL mode intra prediction. For example, the F_{2,8} value of the top-right corner square has been propagated to the other squares along the top-right to bottom-left diagonal of the 4×4 block 400c. The placement of predicted video units in this instance may take one processor cycle to complete using pixel predictor module 318 or 328 of intra prediction unit 34A of FIG. 3A, for example.

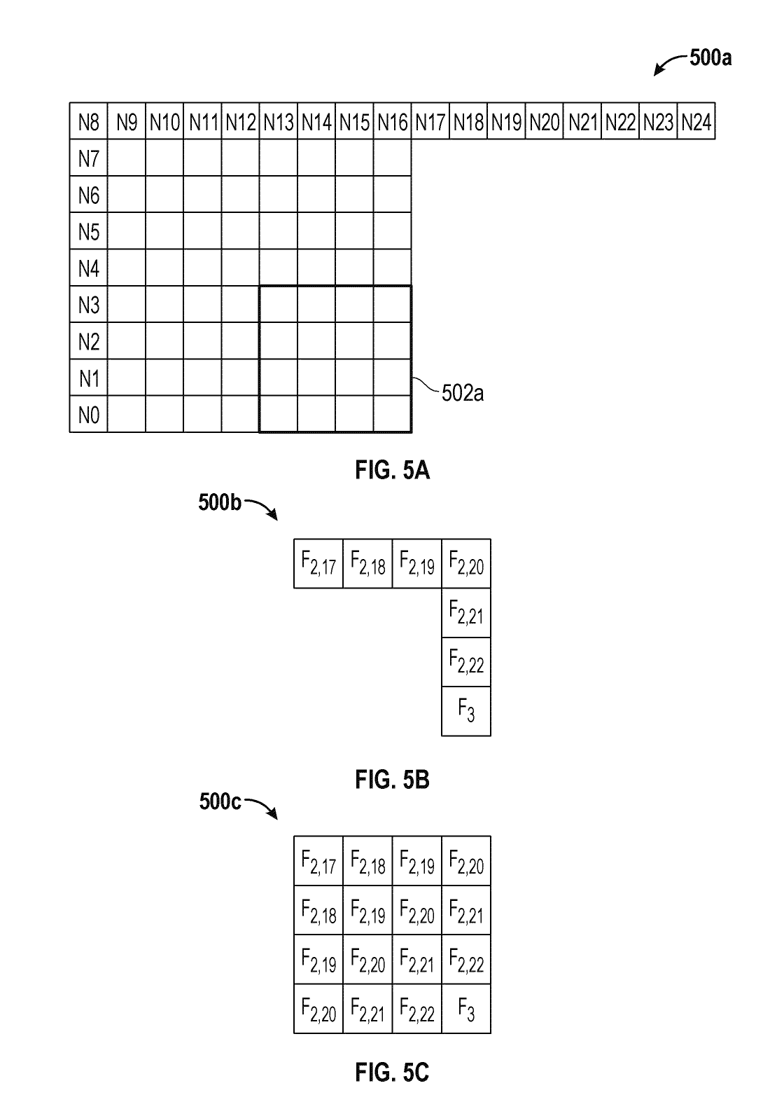

FIGS. 5A-5C illustrate an example intra prediction determination. FIG. 5A shows a highlighted 4×4 sub-block 502a of a 8×8 block 500a arranged for 8×8 diagonal down left (DDL) mode intra prediction. The twenty-five border squares N0, N1, . . . , N24 may represent some or all video units from neighboring video blocks that have been fetched, for example, by neighbor pixel manager module 304 of FIG. 3A. Further, the twenty-five border squares N0, N1, . . . , N24 may be the set of video units from which neighbor fetch module 314 or 324 of FIG. 3A fetches prediction variables or a subset of video units for use in intra prediction. FIG. 5B shows the placement of seven unique predicted video units 500b calculated as function of the prediction variables or appropriate border squares to the 8×8 block, according to 8×8 DLL mode intra prediction. For instance, the top-right corner square may equal a pixel value that is a function in part of border square N20 as indicated by F_{2,20}. The calculation of predicted video units 500b in this instance may take one processor cycle to complete using intermediate value calculator module 316 or 326 of intra prediction unit 34A of FIG. 3A, for example. FIG. 5C shows the placement of the unique predicted video units in squares of a 4×4 predicted video units sub-block 500c, according to 8×8 DLL mode intra prediction. For example, the F_{2,20} value of the top-right corner square has been propagated to the other squares along the top-right to bottom-left diagonal of the 4×4 sub-block 500c. The placement of predicted video units in this instance may take one processor cycle to complete using pixel predictor module 318 or 328 of intra prediction unit 34A of FIG. 3A, for example.

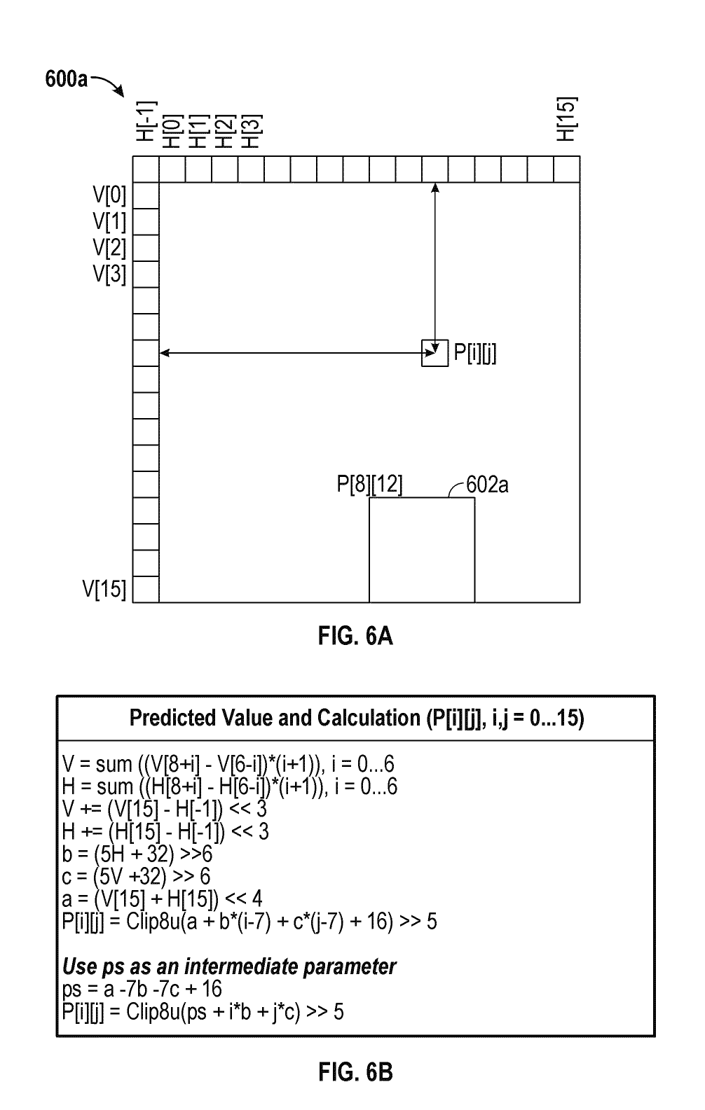

FIGS. 6A-6D illustrate an example intra prediction determination. FIG. 6A shows a highlighted 4×4 sub-block 602a of a 16×16 block 600a arranged for 16×16 planar mode intra prediction. The darker colored border squares may represent some or all video units from neighboring video blocks that have been fetched, for example, by neighbor pixel manager module 304 of FIG. 3A. Further, the darker colored border squares may be the set of video units from which neighbor fetch module 314 or 324 of FIG. 3A fetches prediction variables or a subset of video units for use in intra prediction. FIG. 6B shows a table of algorithms for use in calculation of predication variables or values, such as planar parameters ps, b, or c. The calculation of predicted video units in this case may further take multiple processor cycles to complete using DC/planar calculator module 312 or 322 of intra prediction unit 34A of FIG. 3A, for example. FIG. 6C illustrates the general algorithm for determining the predicted video units for a 4×4 predicted video units sub-block 600c that includes pixel P[i][j] in the top-left corner. The value of A may equal the predicted video unit of the top-left corner pixel of the 4×4 sub-block 600c, and multiples of values b or c may be added to the value of A to determine predicted video units for remaining squares using intermediate value calculator module 316 and/or 326 and pixel predictor module 318 or 328 of intra prediction unit 34A of FIG. 3A, for example. FIG. 6D illustrates a specific algorithm for determining the predicted video units for the highlighted 4×4 sub-block block 602a of FIG. 6A that includes pixel P[8][12] in the top-left corner. The value of each predicted video unit may equal the value indicated in one of the illustrated squares of FIG. 6D plus A, where A=ps+8b+12c. Accordingly, in some aspects, predicted video units for a top row may advantageously be calculated first, and the predicted video units for other rows may be calculated in a next processor cycle. In other aspects, any one row or column may be calculated first, and the predicted video units for other rows or columns may further be calculated in a next processor cycle.

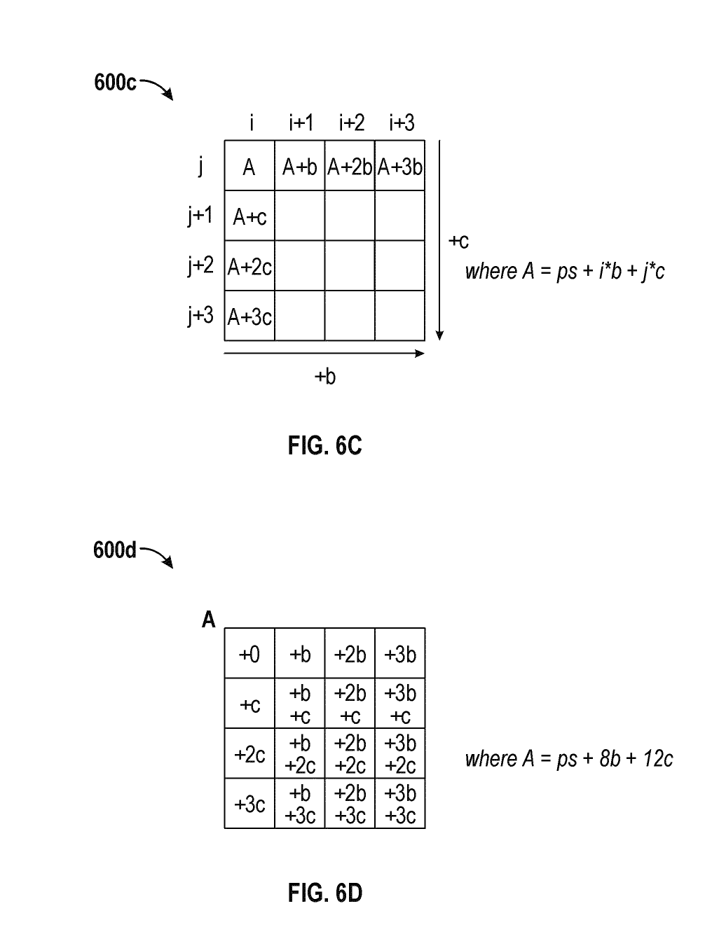

FIG. 7 is a flowchart of an example method 700 for determining predicted video units of a video block. In some aspects, the video block may have a size of 4×4, 8×8, 16×16, or 32×32. Advantageously, method 700 illustrates how prediction unit 32 of video encoder 20 of FIG. 2 may perform intra prediction for video blocks of size 8×8, 16×16, or 32×32 by independently processing video sub-blocks of the 8×8, 16×16, or 32×32 video blocks.

At node 705, method 700 determines whether a video block is an 8×8, 16×16, or 32×32 block. In some aspects, the video block may be a luminance block or a chrominance block, for instance.

If the video block is an 8×8, 16×16, or 32×32 block, at node 710, the 8×8, 16×16, or 32×32 block is divided into a plurality of 4×4 sub-blocks. At node 715, prediction variables for one 4×4 sub-block of the plurality of 4×4 sub-blocks are determined. The prediction variables may be determined based on neighboring video unit information and/or parameters calculated based on neighboring video units of at least one neighboring block of the 8×8, 16×16, or 32×32 block. At node 720, a predicted video unit is determined for each video unit of the one 4×4 sub-block. Intra prediction unit 34 of prediction unit 32 may determine the predicted video units.

At node 725, method 700 decides whether to repeat nodes 715 and 720 and determine predicted video units for additional 4×4 sub-blocks of the plurality of 4×4 sub-blocks. In some aspects, method 700 decides to determine predicted video units once for each 4×4 sub-block of the 8×8, 16×16, 32×32 block. In other aspects, the method 700 decides to determine predicted video units once for some 4×4 sub-blocks but not others (e.g., because some sub-blocks may be known to be identical to a previously determined predicted video sub-blocks). Prediction unit 32, for example, may determine whether to repeat nodes 715 and 720 for additional 4×4 sub-blocks.

If method 700 decides to determine predicted video units for additional 4×4 sub-blocks, method 700 moves to node 715 and determines prediction variables for another 4×4 sub-block of the plurality of sub-blocks. If method 700 decides not to determine predicted video units for additional 4×4 sub-blocks, method 700 terminates.

If the video block is not an 8×8, 16×16, or 32×32 block, the video block accordingly is a 4×4 block in this example. At node 730, prediction variables for the 4×4 block are determined. The prediction variables may be determined based on neighboring video unit information and/or parameters calculated based on neighboring video units of at least one neighboring block of the 4×4 block. At node 735, a predicted video unit is determined for each video unit of the 4×4 block. After node 735, method 700 terminates.

Although aspects of method 700 are discussed using 4×4, 8×8, 16×16, and 32×32 video blocks as examples, method 700 is not limited to those block sizes. Instead, the 4×4 block (including 16 video units) of method 700 may represent a video block having a baseline block size or a baseline total number of video units. For example, the baseline block size can be 2×4 (including 8 video units), 8×5 (including 40 video units), 20×20 (including 400 video units), and the like, in some implementations. The 8×8 block (including 64 video units), 16×16 block (including 256 video units), and 32×32 block (including 1024 video units) of method 700 may represent video blocks having a block size or a total number of video units greater than the baseline block size or the baseline total number of video units, respectively. For example, the block size greater than the baseline block size can be 8×4 (including 32 video units), 15×6 (including 90 video units), and 64×64 (including 4096 video units), and the like, in some implementations. The video blocks having the block size or total number of video units greater than the baseline block size or baseline total number of video units may be divided into sub-blocks having a baseline block size or a baseline total number of video units for processing according to the approaches in this disclosure. In some aspects, video units may be discarded from video blocks or additional video units may be added as padding video units so that the video block may be processed according to method 700.

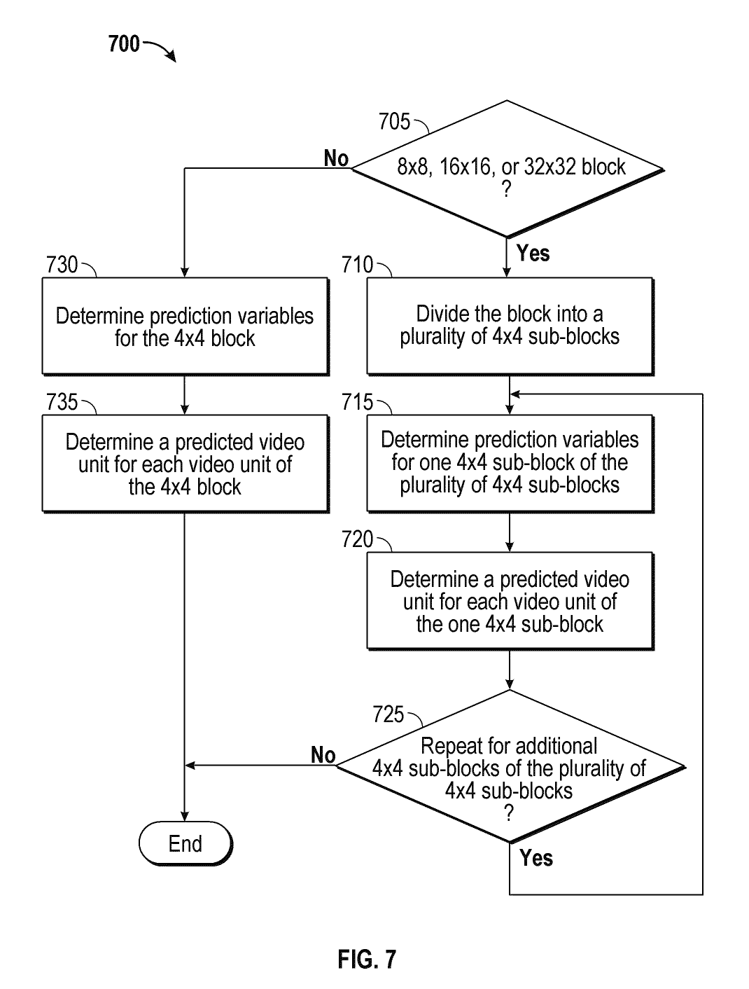

FIG. 8 is a flowchart of an example method 800 for determining predicted video units of a video sub-block. Method 800 may be performed using video encoder 20 of FIG. 2, for instance. Although method 800 is described below with respect to the elements of video encoder 20, other components may be used to implement one or more of the steps.

At node 805, a video block is divided into a plurality of video sub-blocks. The video block may include video units and have an intra prediction mode. Each video sub-block of the plurality of video sub-blocks may include at least a non-zero integer number of video units of the video block. In some aspects, the video block is divided into a plurality of video sub-blocks having a first size. The first size may correspond to a baseline block size or a baseline total number of video units for hardware and/or software used to determine prediction variables and/or predicted video units. Prediction unit 32, for example, may divide the video block.

At node 810, prediction variables for a video sub-block are determined based on the intra prediction mode of the video block. In some aspects, the predictions variables include calculated values based on neighboring video unit pixel values or received values from a neighbor pixel manager that stores neighboring video block pixel information. Further, in some aspects, a predictor may be used to determine the prediction variables, and the predictor may be configured to determine the prediction variables only for video sub-blocks of the baseline block size or the video blocks of the baseline block size. Intra prediction unit 34 of prediction unit 32, for example, may determine the prediction variables.

At node 815, a predicted video unit for each video unit of the video sub-block is determined based on the intra prediction mode of the video block and the prediction variables for the video sub-block. In some aspects, a minimum number of unique predicted video units may be first generated or fetched for the video sub-block. The unique predicted video units may then be used to determine predicted video units for other predicted video units of the video sub-block. Further, in some aspects, a predictor may be used to determine the predicted video units, and the predictor may be configured to determine the predicted video units only for video sub-blocks of the baseline block size or the video blocks of the baseline block size. Intra prediction unit 34, for example, may determine the predicted video units.

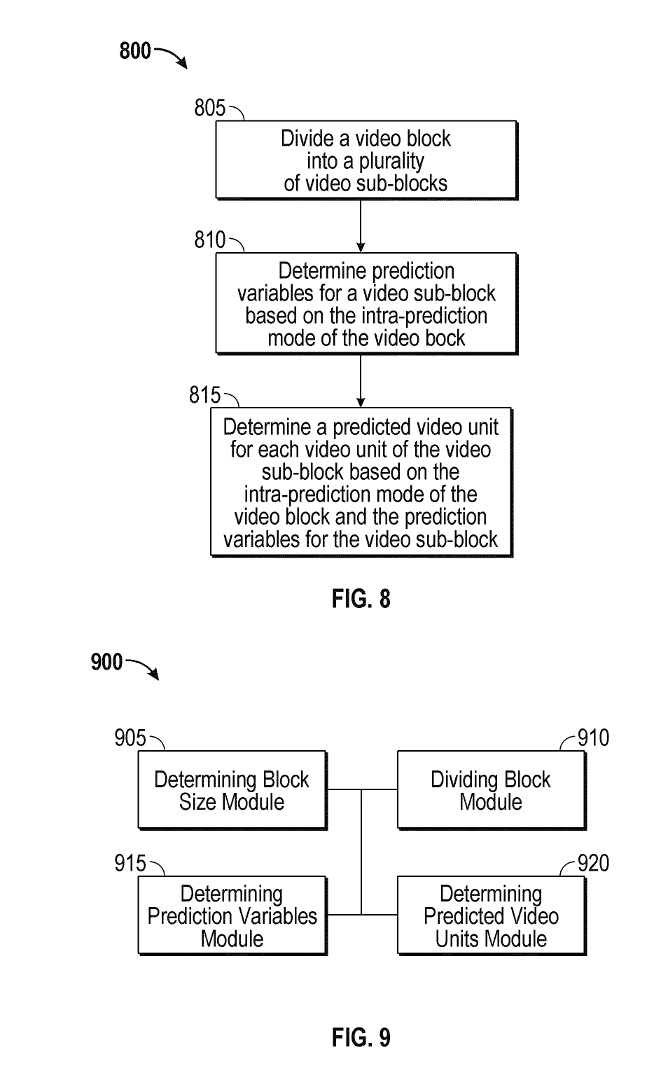

FIG. 9 is a functional block diagram of an example video coder 900 configured to perform intra prediction. Video coder 900 may include determining block size module 905, dividing block module 910, determining prediction variables module 915, and determining predicted video units module 920. Determining block size module 905 may be configured to determine whether a video block is one or more of multiple video block sizes. Determining block size module 905 may correspond to prediction unit 32 of FIG. 2. Dividing block module 910 may be configured to perform one or more of the functions discussed with respect to node 805 of FIG. 8. Dividing block module 910 may correspond to prediction unit 32 of FIG. 2. Determining prediction variables module 915 may be configured to perform one or more of the functions discussed with respect to node 810 of FIG. 8. Determining prediction variables module 915 may correspond to intra prediction unit 34 of prediction unit 32 of FIG. 2. Determining predicted video units module 920 may be configured to perform one or more of the functions discussed with respect to node 815 of FIG. 8. Determining predicted video units module 920 may correspond to intra prediction unit 34 of prediction unit 32 of FIG. 2.

Moreover, in one aspect, means for determining whether a video block is a first size comprises the determining block size module 905. In another aspect, means for dividing the video block into a plurality of video sub-blocks comprises the dividing block module 910. In yet another aspect, means for determining prediction variables for a first video sub-block of the plurality of video sub-blocks comprises the determining prediction variables module 915. In a further aspect, means for determining a predicted video unit for each video unit of the first video sub-block comprises the determining predicted video units module 920.

Information and signals disclosed herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may be implemented in hardware, software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Various embodiments of the disclosure have been described. These and other embodiments are within the scope of the following claims.

What is claimed is:

1. An apparatus for coding video data including video blocks, the apparatus comprising:
a processor configured to
divide a video block into a plurality of video sub-blocks having a first size, the video block comprising video units and having an intra prediction mode, each video sub-block of the plurality of video sub-blocks comprising at least a non-zero integer number of video units of the video block,
determine prediction variables for a first video sub-block of the plurality of video sub-blocks based on the intra prediction mode of the video block, and
determine a predicted video unit for each video unit of the first video sub-block based on the intra prediction mode of the video block and the prediction variables for the first video sub-block; and
a memory configured to store the predicted video units.

2. The apparatus of claim 1, wherein the processor is configured to use a predictor to determine the prediction variables and the predicted video units, the predictor configured to determine the prediction variables and the predicted video units only for the video blocks of the first size or the video sub-blocks of the first size.

3. The apparatus of claim 1, wherein the processor is further configured to:
determine whether the video block is of the first size; and
in response to determining that the video block is of the first size,
determine the prediction variables for the video block based on the intra prediction mode of the video block, and
determine the predicted video unit for each video unit of the video block based on the intra prediction mode of the video block and the prediction variables for the video block.

4. The apparatus of claim 1, wherein the prediction variables comprise pixel values of neighboring video units of at least one neighboring video block of the video block.

5. The apparatus of claim 4, wherein the processor is configured to determine the pixel values based on stored pixel values in a neighbor pixel manager.

6. The apparatus of claim 1, wherein the prediction variables comprise parameters calculated based on neighboring video units of at least one neighboring video block of the video block.

7. The apparatus of claim 1, wherein the prediction variables comprise pixel values of neighboring video units of at least one neighboring video block of the video block and parameters calculated based on the neighboring video units.

8. The apparatus of claim 1, wherein the processor is further configured to:
determine the prediction variables for a second video sub-block of the plurality of video sub-blocks based on the intra prediction mode of the video block; and
determine the predicted video unit for each video unit of the second video sub-block based on the intra prediction mode of the video block and the prediction variables for the second video sub-block,
wherein the processor is configured to determine the prediction variables for the second video sub-block in parallel with determining the prediction variables for the first video sub-block.

9. The apparatus of claim 1, wherein the intra prediction mode of the video block comprises one of a directional mode, a mean mode, and a planar mode.

10. A method for coding video data including video blocks, the method comprising:
dividing a video block into a plurality of video sub-blocks having a first size, the video block comprising video units and having an intra prediction mode, each video sub-block of the plurality of video sub-blocks comprising at least a non-zero integer number of video units of the video block;
determining prediction variables for a first video sub-block of the plurality of video sub-blocks based on the intra prediction mode of the video block; and
determining a predicted video unit for each video unit of the first video sub-block based on the intra prediction mode of the video block and the prediction variables for the first video sub-block.

11. The method of claim 10, wherein said determining the prediction variables and the predicted video units comprises using a predictor to determine the prediction variables and the predicted video units, the predictor configured to determine the prediction variables and the predicted video units only for the video blocks of the first size or the video sub-blocks of the first size.

12. The method of claim 10, further comprising:
determining whether the video block is of the first size; and
in response to determining that the video block is of the first size,
determining the prediction variables for the video block based on the intra prediction mode of the video block, and
determining the predicted video unit for each video unit of the video block based on the intra prediction mode of the video block and the prediction variables for the video block.

13. The method of claim 10, wherein the prediction variables comprise pixel values of neighboring video units of at least one neighboring video block of the video block.

14. The method of claim 13, wherein said determining the prediction variables comprises determining the pixel values based on stored pixel values in a neighbor pixel manager.

15. The method of claim 10, wherein the prediction variables comprise parameters calculated based on neighboring video units of at least one neighboring video block of the video block.

16. The method of claim 10, wherein the prediction variables comprise pixel values of neighboring video units of at least one neighboring video block of the video block and parameters calculated based on the neighboring video units.

17. The method of claim 10, further comprising:
determining the prediction variables for a second video sub-block of the plurality of video sub-blocks based on the intra prediction mode of the video block; and
determining the predicted video unit for each video unit of the second video sub-block based on the intra prediction mode of the video block and the prediction variables for the second video sub-block,
wherein the prediction variables for the second video sub-block are determined in parallel with determining the prediction variables for the first video sub-block.

18. The method of claim 10, wherein the intra prediction mode of the video block comprises one of a directional mode, a mean mode, and a planar mode.

19. An apparatus for coding video data including video blocks, the apparatus comprising:
means for dividing a video block into a plurality of video sub-blocks having a first size, the video block comprising video units and having an intra prediction mode, each video sub-block of the plurality of video sub-blocks comprising at least a non-zero integer number of video units of the video block;
means for determining prediction variables for a first video sub-block of the plurality of video sub-blocks based on the intra prediction mode of the video block; and
means for determining a predicted video unit for each video unit of the first video sub-block based on the intra prediction mode of the video block and the prediction variables for the first video sub-block.

20. A non-transitory, computer-readable storage medium comprising instructions that upon execution in a processor cause the processor to:
divide a video block into a plurality of video sub-blocks, the video block comprising video units and having an intra prediction mode, each video sub-block of the plurality of video sub-blocks comprising at least a non-zero integer number of video units of the video block;
determine prediction variables for a first video sub-block of the plurality of video sub-blocks based on the intra prediction mode of the video block; and
determine a predicted video unit for each video unit of the first video sub-block based on the intra prediction mode of the video block and the prediction variables for the first video sub-block.
